(19) United States
(12) Patent Application Publication
(10) Pub. No.: US 2007/0182380 A1
(43) Pub. Date: Aug. 9, 2007

(54) System and method for charging a battery

(76) Inventors: Robert W. DiGiovanna, Shirley, NY (US); Edward Cantillo, Mt. Sinai, NY (US)

Correspondence Address: FAY KAPLUN & MARCIN, LLP, 15O BROADWAY, SUITE 702, NEW YORK, NY, 10038, US

(21) Appl. No.: 11/341,824

(22) Filed: Jan. 27, 2006

(51) Int. Cl. H02J 7/04

(52) U.S. Cl. 320/150

(57) ABSTRACT

A system and method for recharging a rechargeable battery. A battery charger includes a measuring element to measure a temperature of the rechargeable battery, the battery charger disables a charge to the rechargeable batter when the temperature is greater than a first predetermined threshold, the measuring element re-measures the temperature of the battery after a predetermined time period from the disabling of the charge and the battery charger enables the charge when the re-measured temperature is less than a second predetermined threshold, wherein the second predetermined threshold is based on the first predetermined threshold.

### BACKGROUND

Since the advent of batteries, there has been many different techniques employed to recharge batteries. Originally, nickel cadmium rechargeable batteries were used. In order to increase capacity and for safety of the environment, nickel metal hydride (NiMH) rechargeable batteries were introduced. Rechargeable batteries allow for the convenience of any user to reuse batteries by utilizing a charger that will convert a discharged battery into a charged battery ready for reuse. Rechargeable batteries convert electrical energy into chemical energy so that a reverse reaction occurs inside the battery thus returning the battery to its original state where there is energy ready to be used.

### SUMMARY OF THE INVENTION

A method for measuring a temperature of a battery to be recharged, disabling a battery charger when the temperature is greater than a first predetermined threshold, enabling the battery charger after a predetermined time period, re-measuring the temperature of the battery; and recharging the battery when the re-measured temperature is less than a second predetermined threshold, where the second predetermined threshold is based on the first predetermined threshold.

A system having a rechargeable battery and a battery charger including a measuring element to measure a temperature of the rechargeable battery, the battery charger disabling a charge to the rechargeable batter when the temperature is greater than a first predetermined threshold, the measuring element re-measuring the temperature of the battery after a predetermined time period from the disabling of the charge and the battery charger enabling the charge when the re-measured temperature is less than a second predetermined threshold, wherein the second predetermined threshold is based on the first predetermined threshold.

### DESCRIPTION OF THE DRAWINGS

FIG. 1 illustrates an exemplary method of recharging a rechargeable battery according to the present invention.

FIG. 2 illustrates an exemplary system of a rechargeable battery and a charger with its component parts according to the present invention.

### DETAILED DESCRIPTION

The present invention may be further understood with reference to the following description and the appended drawings, wherein like elements are referred to with the same reference numerals. The exemplary embodiment of the present invention describes a method for charging a battery to prevent overcharging and increased battery temperature due to repeated insertion into a charger. The battery charging, overcharging, and increased battery temperature will be discussed in detail below.

In the exemplary embodiments, the exemplary battery is described as a rechargeable Nickel Metal Hydride (NiMH) battery. However, those of skill in the art will understand that the use of the NiMH battery is only exemplary and that the present invention may be applied to any type of rechargeable battery. Other examples of rechargeable batteries include nickel cadmium batteries and lithium ion batteries. All these battery types exhibit a system that utilize a reverse reaction where electrons are flowed in an opposite direction of when the battery is discharged in order to recharge the battery.

It should be noted that the term “battery” will be used to encompass both a battery and a cell. Technically, a cell is a single unit, potentially one cell in a battery of multiple cells or possibly the entire device. A battery is a device for creating or storing electrical energy composed of several similar cells that are connected together. However, common usage of the term “battery” encompasses both a cell and a battery and the following description will use the term “battery” interchangeably to mean both a cell and a battery.

A rechargeable battery (e.g., a NiMH battery) is able to be recharged so that it may be used repeatedly. This is accomplished by providing electrical energy to the battery. The electrical energy is converted into chemical energy by the battery. When the battery is used to provide energy to a load, the chemical reaction is reversed and electrical energy is provided to the load. An inherent problem that arises when the battery is continuously charged under different levels of discharge is that the chemical reaction inside the battery may produce heat that may permanently damage the battery. Such a condition may occur when, for example, a fully charged battery is recharged or when a partially discharged battery is charged beyond its capacity. Any energy not used to recharge the battery converts to heat which raises the temperature of the battery. Consequently, the life of a rechargeable battery (i.e., the number of times the battery may effectively be recharged) is significantly shortened.

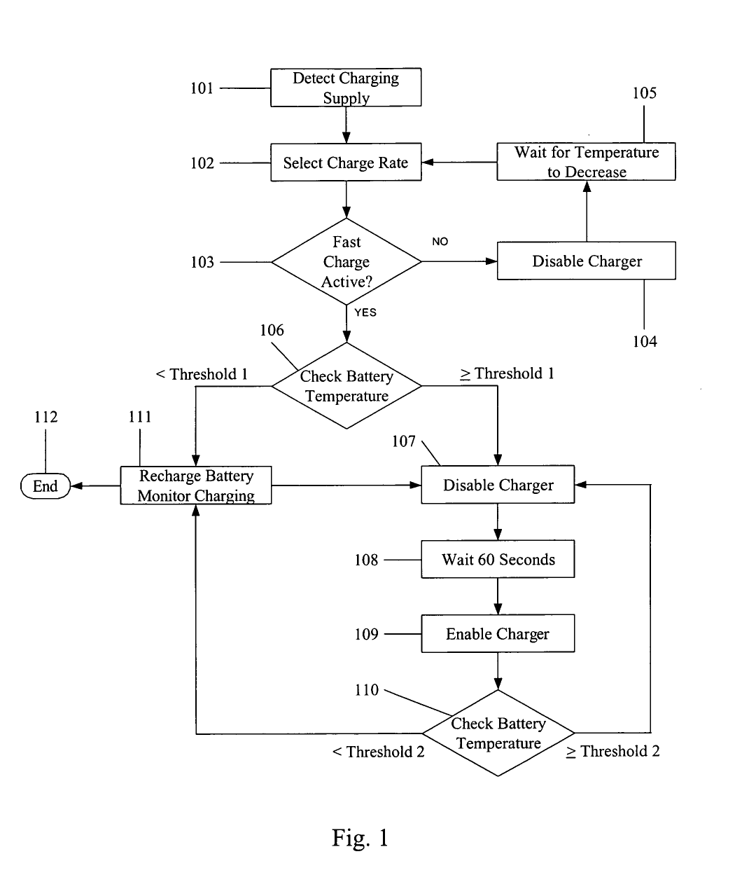

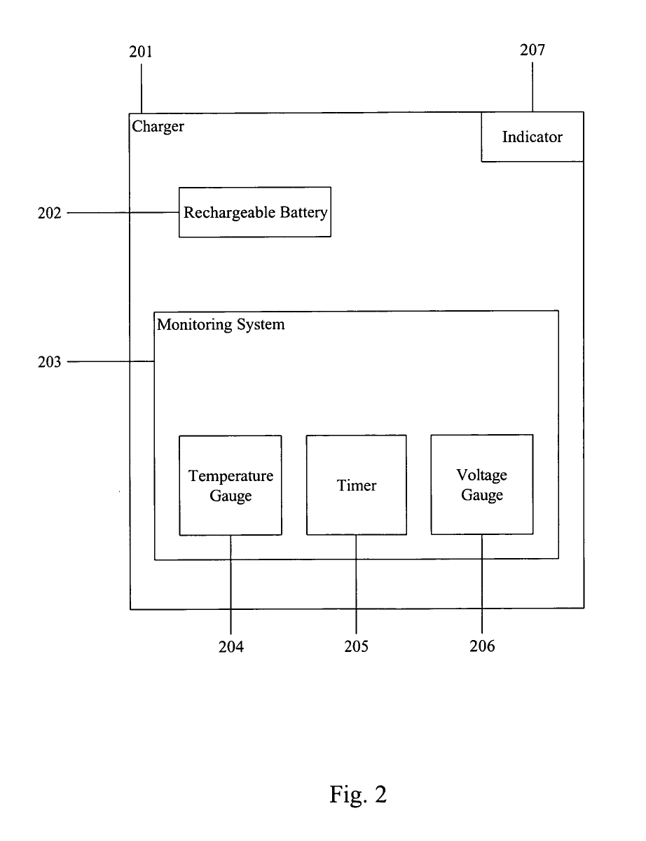

FIG. 1 illustrates an exemplary method 100 to prevent overcharging and increased battery temperature from repeated charging according to the present invention. The method 100 described in FIG. 1 acts as an intelligence system in that it uses several parameters (e.g., charging rate, timer, temperature) in order to determine when a battery is allowed to be recharged and when the system must allow the battery to reach an acceptable condition for recharging. The method 300 will be described with reference to FIG. 2 that shows a battery charger 201, a rechargeable battery 202, a monitoring system 204 and its component parts (e.g., a temperature gauge 204, a timer 205, and a voltage gauge 206), and an indicator 207.

In Step 101, the charger 201 detects the charging power supply. For example, if the device that includes the arrangement of FIG. 2 is placed in a recharging cradle, the charger 201 may detect the charging power supply that is provided by the recharging cradle. Those of skill in the art will understand that the use of a recharging cradle is only exemplary and that there are other types of charging power supplies that may be used and detected in step 101, e.g., directly plugging the device into a wall outlet, etc. In step 101, the charger 201 also learns the level of charge current or the charge rate that the charger 201 is allowed to draw from the recharging power supply, e.g., the recharging cradle. For example, if the charging cradle is host or PC powered, the recharging cradle may be limited to a set charging current, e.g., 500 mA. In other situations, the charging current may not be limited to any particular value. By determining this level of charge current, the charger 201 may determine the next set of parameters in order to effectively charge the rechargeable battery 202 correctly and in the most effective manner.

In Step 102, after learning of the level of charge current in Step 101 (e.g., full current, partial current), the charger selects an appropriate charge rate. Thus, using the example of a host or PC powered charging cradle, the charger 201 may select a charge rate of 500 mA to recharge the rechargeable battery 202. However, where the level of charge current is not limited by the recharging device, the charger 201 may use a full current charge. The charging of the rechargeable battery 202 may be commenced in step 201.

In Step 103, the charger 201 determines if it is receiving a fast charge signal. The charger 201 will be receiving the fast charge signal if the charge is active. However, if the temperature is detected to be greater than some safety value (e.g., 55° C.), the charge will not be active and the charger 201 will not receive the fast charge signal. If Step 103 determines that the fast charge is active, then the method proceeds to Step 106. Otherwise, if Step 103 determines that the fast charge is inactive, then Steps 104 and 105 are used to ensure that the battery 202 reaches an appropriate condition in order to recharge.

In Steps 104 and 105, the rechargeable battery 202 temperature exceeds safe limits that allow for the rechargeable battery 202 to be recharged effectively. Thus, in Step 104, the charger 201 disables itself so that no processes take place that may increase the temperature further. In Step 105, the temperature of the rechargeable battery 202 is allowed to drop until the appropriate temperature is reached. The charger 201 will include functionality (e.g., temperature gauge 204) that detects the temperature of the rechargeable battery 202 when placed in the charger 201. The temperature gauge 204 will measure the temperature at certain time intervals (e.g., every five minutes). Steps 104 and 105 serve as safety parameters to allow the rechargeable battery 202 to recharge optimally and to prolong its life. Once Steps 104 and 105 are completed, the process returns to Step 102, where a charge rate is selected. Once returned to Step 102, Step 103 will determine once again if the fast charge is active and whether the temperature of the charger has reached an appropriate temperature.

In Step 106, a temperature of the rechargeable battery 202 is measured with a temperature gauge 204. In Step 106, the temperature of the rechargeable battery 202 with respect a threshold value is determined. The threshold value may be set at any temperature based on a variety of factors, i.e., the rechargeable battery, the device in which it is used, etc. Thus, the manufacturer of the battery, the device, the charging cradle, etc, may provide optimum threshold temperatures for use with their product. The charger 201 may include a preset temperature threshold that may not be changed by the user (e.g., the threshold may be set at the factory) or the device having the charger 201 may include a user interface for the user to set or reset the threshold temperature stored in the charger 201 (e.g., individual users may set the threshold or the owner of the device may set the threshold temperature on an enterprise level). An exemplary threshold temperature may be, for example, 45° C. However, it should be noted that the threshold temperature of 45 □C is only exemplary and that other chargers may contain a threshold temperature that is higher or lower than 45° C. Referring back to Step 106, if the temperature of the rechargeable battery 202 is greater than or equal to the threshold temperature, then the process proceeds to Step 107. If the temperature of the rechargeable battery 202 is less than threshold temperature, then the process proceeds to Step 111.

In Step 107, similar to Step 105, the charger 201 is disabled. This prevents the charger from increasing the temperature of the rechargeable battery 202 by stopping any processes that may increase an already high temperature range for recharging batteries.

Once the charger 201 is disabled in Step 107, Step 108 allows the rechargeable battery 202 an opportunity to decrease its temperature by waiting a certain time interval. In the exemplary method 100, the time interval used before continuing the process is set at 60 seconds. However, it should be noted that the time interval of 60 seconds is only exemplary and that any other time interval may be used (e.g., 30 seconds, 2 minutes, etc.). After waiting the predetermined time interval, the charger 201 is again enabled and the process continues.

In Step 110, the temperature of the rechargeable battery 202 is again tested. Step 110 serves as a failsafe so that the process does not automatically continue despite the temperature of the rechargeable battery 202 still being above a threshold temperature. However, in Step 110, the threshold temperature may be changed from the first threshold value used in Step 106. For example, the threshold temperature used in Step 110 may be lowered by 2° C. from the threshold temperature used in Step 106, e.g., Threshold 1 =45° C. and Threshold 2 =43° C. This allows for more definiteness in terms of whether the rechargeable battery 202 has reached an appropriate temperature for it to be recharged. Again, it should be noted that the lowering of the threshold temperature in Step 110 by 2° C. is only exemplary and that other options for a second threshold temperature are available such as lowering the original threshold temperature by 3, 4, or 5° C. It may also be considered that the threshold temperature in Step 110 may be the same (or even higher) than that in Step 106. While the preferred embodiment is for the second temperature threshold to be decreased, there may be situations where an increase is allowable.

If Step 110 determines that the temperature of the rechargeable battery 202 is still greater than or equal to the second threshold temperature, then the process returns to Step 107 so that the charger 201 may be disabled again to attempt to lower the temperature of the rechargeable battery 202. This cycle will continue until the rechargeable battery 202 has reached an appropriate temperature for recharging. Once the rechargeable battery 202 reaches a temperature that is lower than the second threshold temperature, then the process continues to Step 111.

In Step 111, the rechargeable battery 202 is recharged. The system will include functionality to allow a user to know when the charger 201 is recharging the rechargeable battery 202 by utilizing an indicator 207. The indicator 207 may include, for example, blinking a light emitting diode (LED) and playing evenly spaced sounds. In addition to allowing the user know when the charger 201 is recharging the rechargeable battery 202, the charger 201 will include functionality that allows the system to monitor the fast charge with a monitoring system 203. The monitoring system 203 serves as an assurance that the rechargeable battery 202 will be fully charged rather than charging for a set period of time thereby running a risk of only partial recharging.

The monitoring system 203 may determine different parameters to decide if the charging is complete or if another cycle must be run in order to fully recharge the rechargeable battery 202. Such parameters include, for example, temperature, time, and voltage by utilizing the temperature gauge 204, a timer 205, and a voltage gauge 206, respectively. In order for the process to terminate at Step 112, a combination of the parameters for voltage and time will be used as will be discussed below.

If the temperature gauge 204 of the monitoring system 203 concludes that the temperature has increased beyond the threshold temperature used in Step 106 during the recharging process, then the process proceeds to Step 107. At Step 107, the cycle process beings in order to lower the temperature of the rechargeable battery 202 until the second threshold temperature of Step 110 is reached.

If the timer 205 of the monitoring system 203 concludes that a time of a cycle has expired, then the process proceeds to Step 107 as well. The system will include the timer 205 so that recharging is done in time intervals. Such a time interval may be, for example, 133% of a normal fast charge time. A normal fast charge time may be, for example, 120 minutes. Thus, an exemplary time interval for recharging would be 160 minutes. Due to the possibility of the rechargeable battery 202 reaching an increase in temperature that is lower than the threshold temperature of Step 106 but higher than the second threshold temperature of Step 110, Step 111 would serve as a failsafe for temperature by using time. As such, an unnecessary increase in temperature will not result.

1 If the voltage gauge 206 of the monitoring system 203 concludes that the voltage of the rechargeable battery 202 has not reached its optimal (i.e., maximum) capacity, then the process proceeds to Step 107. After a temperature determination that it may continue to recharge, the charger 201 will continue to recharge the rechargeable battery 202 until the optimal capacity is reached.

In Step 111, if the monitoring system 203 concludes that the rechargeable battery 202 has reached the optimal capacity using the voltage gauge 206 and does so within a pre-determined time interval using the timer 205, then the process ends at Step 112. Upon completion of the recharging, the charger 201 will also include functionality to indicate to a user that the process has terminated and that the rechargeable battery 202 is fully recharged by utilizing the indicator 207. The indicator may include, for example, emitting a steady light from a LED and playing a constant sound. It should be noted that there may be two independent indicators to display when the charger 201 is charging the rechargeable battery 202 and when the charger 201 has charged the rechargeable battery 202.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A method, comprising:
measuring a temperature of a battery to be recharged;
disabling a battery charger when the temperature is greater than a first predetermined threshold;
enabling the battery charger after a predetermined time period;
re-measuring the temperature of the battery; and
recharging the battery when the re-measured temperature is less than a second predetermined threshold, where the second predetermined threshold is based on the first predetermined threshold.

2. The method of claim 1, wherein the battery is one of an individual cell and a multi-cell battery.

3. The method of claim 1, further comprising:
detecting a level of charge current being supplied to the battery.

4. The method of claim 1, wherein the first predetermined threshold temperature is 45° C.

5. The method of claim 1, wherein the predetermined time period is one of 30 seconds, 60 seconds, and 120 seconds.

6. The method of claim 1, wherein the second predetermined threshold temperature is less than the first predetermined threshold temperature.

7. The method of claim 3, further comprising:
selecting a charge rate based on the level of charge current being supplied to the battery.

8. The method of claim 1, further comprising:
receiving a signal indicating a charge to the battery is active; and
disabling a charger when the signal is not active.

9. The method of claim 1, further comprising:
monitoring the battery charger while charging the battery.

10. A system, comprising:
a rechargeable battery; and
a battery charger including a measuring element to measure a temperature of the rechargeable battery, the battery charger disabling a charge to the rechargeable batter when the temperature is greater than a first predetermined threshold, the measuring element re-measuring the temperature of the battery after a predetermined time period from the disabling of the charge and the battery charger enabling the charge when the re-measured temperature is less than a second predetermined threshold, wherein the second predetermined threshold is based on the first predetermined threshold.

11. The system of claim 10, wherein the battery charger detects a level of charge current being supplied to the rechargeable battery.

12. The system of claim 10, wherein the rechargeable battery and the battery charger are included in a mobile computing device.

13. The system of claim 10, wherein the rechargeable battery is one of an individual cell and a multi-cell battery.

14. The system of claim 10, wherein the first predetermined threshold temperature is set from 40° C.-50° C.

15. The system of claim 10, wherein the predetermined time period is one of 30 seconds, 60 seconds, and 120 seconds.

16. The system of claim 10, wherein the second predetermined threshold temperature is less than the first predetermined threshold temperature.

17. The system of claim 10, wherein the measuring element is initialized to measure the temperature of the rechargeable battery upon the battery charger detecting a triggering event.

18. The system of claim 17, wherein the triggering event is placement of a device including the battery charger and the rechargeable battery into a charging cradle.

19. The system of claim 10, further comprising:
a monitoring element to monitor the battery charger while charging the battery.

20. The system of claim 19, wherein the monitoring element is comprised of a temperature gauge, a timer, and a voltage gauge.

21. A system, comprising:
a measuring means for measuring a temperature of a rechargeable battery;
a disabling means for disabling a charge to the rechargeable batter when the temperature is greater than a first predetermined threshold, wherein the measuring means re-measures the temperature of the battery after a predetermined time period from the disabling of the charge; and
an enabling means for enabling the charge when the re-measured temperature is less than a second predetermined threshold, wherein the second predetermined threshold is based on the first predetermined threshold.
